(19) United States
(12) Patent Application Publication
(10) Pub. No.: US 2024/0306242 A1
(43) Pub. Date: Sep. 12, 2024

(54) SYSTEM AND METHOD FOR PROVIDING RRC INACTIVE MODE ENHANCED PAGING FOR MOBILE TERMINATING-SMALL DATA TRANSFER

(71) Applicant: RAKUTEN MOBILE, INC., Tokyo (JP)

(72) Inventors: Pankaj SHETE, Tokyo (JP); Awn MUHAMMAD, Tokyo (JP); Kenichiro AOYAGI, Tokyo (JP)

(73) Assignee: RAKUTEN MOBILE, INC., Tokyo (JP)

(21) Appl. No.: 18/011,314

(22) PCT Filed: Sep. 19, 2022
(86) PCT No.: PCT/US2022/043942

§ 371 Date: Dec. 19, 2022

(51) Int. Cl. H04W 76/27; H04W 52/02; H04W 68/02

(52) U.S. Cl. CPC H04W 76/27; H04W 52/0229; H04W 68/02

(57) ABSTRACT

A method for performing an enhanced paging procedure by a user equipment (UE), includes: receiving, from a radio access network (RAN) node, information for determining a location in a first channel allocated to the UE for downlink data transmissions while the UE is in a Radio Resource Control (RRC) Inactive mode; transitioning from an RRC Connected mode to the RRC Inactive mode; reading a paging message indicating the UE for paging; and reading, while in the RRC Inactive mode, downlink data at the location in the first channel determined by the UE based on the received information.

### BACKGROUND

In related art telecommunications standards (e.g., 3GPP specifications for LTE, 5G, etc.), the Radio Resource Control (RRC) protocol defines the signaling exchanged between user equipment (UE) and a base station over the radio interface. The RRC is used for a variety of different functions, including connection establishment and release, broadcast of system information related to characteristics of the radio interface, radio bearer establishment, RRC connection mobility procedures (i.e., handovers), and paging notifications.

The operation of the RRC is guided by a state machine that defines the various RRC states that a UE may be present in. These states include RRC Connected, RRC Idle, and RRC Inactive (introduced in 5G). The different RRC states (or modes) determine the amount of control, mobility management, and radio resources allocated to a UE, with different amounts of energy consumed in each state.

In particular, the RRC Idle mode is the mode that a UE is in when initially powered on, and consumes the least amount of energy. The UE can move to the RRC Connected mode with a connection establishment procedure to the radio access network (RAN) followed by an initial attachment to the core network and default bearer setup for data transfer. In the RRC Connected mode, the UE is allocated the most amount of resources, and therefore consumes the most energy. To achieve power savings, the UE moves to the RRC Inactive mode if there is no activity for a period of time. In the Inactive mode, the RRC context (i.e., the parameters necessary for communication between the device and the network) is maintained in both the device and the base station and the core network connection is kept, but the RRC connection is suspended thereby conserving the UE's battery power.

In both the RRC Idle and Inactive modes, the UE can receive a paging message from the network. Paging is the mechanism by which the network informs the UE that there is something for it. FIG. 1 illustrates a paging procedure in the related art. Referring to FIG. 1, the UE transitions from the RRC Connected state to Inactive using the RRC Release procedure. To this end, an RRC Release message is transmitted from the base station (gNB) to the UE.

FIG. 2 illustrates an RRC Release message definition in the related art. Referring to FIG. 2, the RRC Release message includes a SuspendConfig field that indicates a configuration for the RRC Inactive state. Among the information provided in SuspendConfig is a paging cycle (ran-PagingCycle), which is a UE specific cycle for RAN-initiated paging, or the discontinuous reception (DRX) cycle.

Referring back to FIG. 1, while in the idle or inactive state, the UE periodically wakes up and monitors the physical downlink control channel (PDCCH) for a paging indication in one Paging Occasion per DRX cycle. The Paging Occasion is monitored based on a defined search space for paging (pagingSearchSpace) included in the PDCCH's cell specific configuration parameters (PDCCH-ConfigCommon).

When there is some downlink (DL) data to be transmitted to the UE in the RRC Idle or Inactive mode, the Access and Mobility Function (AMF) of the core network may initiate the paging procedure with the base station, and the base station may in turn transmit a paging indication encrypted by a paging radio network temporary identifier (P-RNTI). The UE uses the P-RNTI to scramble or decrypt the paging indication in the PDCCH and then checks the paging message on the paging channel (PCH) of the physical downlink shared channel (PDSCH).

FIG. 3 illustrates a paging message definition in the related art. Referring to FIG. 3, in the paging message transmitted on the PCH, UEs are paged via their S-TMSI (Serving Temporary Mobile Subscriber Identity), which uniquely identifies each UE. The UE decodes the paging message and checks whether its S-TMSI is included in the paging record (PagingRecord). The paging record may optionally include an accessType parameter indicating whether the paging message is originated due to a Protocol Data Unit (PDU) session from non-3GPP access.

Referring back to FIG. 1, if the UE finds its identity (S-TMSI) in the paging record of the paging message, it will then perform an RRC connection setup in order to receive the DL data in the RRC Connected mode.

As described above, in the related art paging procedure, the UE must decode a paging message and perform an RRC connection setup (RRC resume procedure) to transition to an RRC Connected state, activate a bearer, and schedule downlink data in order to receive the data. Thus, the amount of signaling and radio resource overhead involved to receive even a small amount of data is proportionately high, resulting in inefficient resource utilization, power consumption, and increased latency.

### SUMMARY

Aspects of one or more embodiments provide an enhanced paging procedure in which a user equipment (UE) can receive downlink data in a Radio Resource Control (RRC) Inactive mode without performing an RRC resume procedure or transitioning to an RRC Connected state.

Aspects of one or more embodiments provide systems and methods for transmitting small data in a preconfigured PDSCH location, which a UE in an RRC Inactive mode can read after decoding a paging message without transitioning to an RRC Connected state.

According to aspects of one or more example embodiments, a method for performing an enhanced paging procedure by a user equipment (UE), includes: receiving, from a radio access network (RAN) node, information for determining a location in a first channel allocated to the UE for downlink data transmissions while the UE is in a Radio Resource Control (RRC) Inactive mode; transitioning from an RRC Connected mode to the RRC Inactive mode; reading a paging message indicating the UE for paging; and reading, while in the RRC Inactive mode, downlink data at the location in the first channel determined by the UE based on the received information.

The reading the downlink data may include, based on determining that the paging message includes information indicating a cause of the paging to be a small data transmission (SDT), reading the downlink data at the location in the first channel determined by the UE based on the received information.

The received information may be received in an RRC Release message from the RAN node.

The first channel may be a physical downlink shared channel (PDSCH).

The reading the paging message may include: identifying a paging indication in a Paging Occasion on a physical downlink control channel (PDCCH); and based on identifying the paging indication, reading the paging message from a paging channel (PCH) on the PDSCH.

The received information may include at least one parameter indicating a plurality of locations in the PDSCH respectively corresponding to a plurality of UEs; and the UE may determine the location allocated thereto, from among the plurality of locations, based on identification information of the UE.

The identification information of the UE may be a numerical value; and the UE may determine the location allocated thereto, from among the plurality of locations, based on A mod B, where A is the identification information of the UE and B is a total number of the plurality of UEs.

The received information may include: a parameter indicating a distance, on a time domain, between the paging message on the PDSCH and a first location among a plurality of locations allocated for small data transmissions on the PDSCH, and at least one parameter indicating the plurality of locations in the PDSCH respectively corresponding to a plurality of UEs; and wherein the at least one parameter indicating the plurality of locations may include at least one of a total number of the plurality of locations, a number of locations per a unit of the time domain, and a number of locations per a unit of a frequency domain.

According to aspects of one or more example embodiments, a non-transitory computer-readable recording medium has recorded thereon instructions executable by at least one processor for performing the above method.

According to aspects of one or more example embodiments, an apparatus for performing an enhanced paging procedure over a telecommunications network, includes: a memory storing instructions; and at least one processor configured to execute the instructions to: receive, from a radio access network (RAN) node, information for determining a location in a first channel allocated to the apparatus for downlink data transmissions while the apparatus is in a Radio Resource Control (RRC) Inactive mode; transition from an RRC Connected mode to the RRC Inactive mode; read a paging message indicating the apparatus for paging; and read, while in the RRC Inactive mode, downlink data at the location in the first channel determined based on the received information.

The at least one processor may be configured to execute the instructions to read the downlink data based on determining that the paging message includes information indicating a cause of the paging to be a small data transmission (SDT).

The received information may be received in an RRC Release message from the RAN node.

The first channel may be a physical downlink shared channel (PDSCH).

The received information may include at least one parameter indicating a plurality of locations in the PDSCH respectively corresponding to a plurality of UEs; and the at least one processor may be configured to execute the instructions to determine the location allocated thereto, from among the plurality of locations, based on identification information of the apparatus.

The identification information may be a numerical value; and the at least one processor may be configured to execute the instructions to determine the located allocated thereto, from among the plurality of locations, based on A mod B, where A is the identification information of the apparatus and B is a total number of the plurality of UEs.

The received information may include: a parameter indicating a distance, on a time domain, between the paging message on the PDSCH and a first location among a plurality of locations allocated for small data transmissions on the PDSCH, and at least one parameter indicating the plurality of locations in the PDSCH respectively corresponding to a plurality of UEs; and wherein the at least one parameter indicating the plurality of locations may include at least one of a total number of the plurality of locations, a number of locations per a unit of the time domain, and a number of locations per a unit of a frequency domain.

According to aspects of one or more example embodiments, a method for performing an enhanced paging procedure by a RAN node, includes: generating an RRC Release message including parameters for determining a location of a first channel allocated for small data transmissions to a UE in an RRC Inactive mode; transmitting, to the UE, an RRC Release message to transition the UE from an RRC Connected mode to the RRC Inactive mode; receiving downlink (DL) data for the UE from a core network; based on receiving the DL data, transmitting a paging message to the UE; and based on receiving the DL data, transmitting the DL data to the UE in the RRC Inactive mode at the location of the first channel determined by the RAN node based on at least the parameters included in the RRC Release message.

The first channel may be a physical downlink shared channel (PDSCH); the parameters in the RRC Release message may include at least one parameter indicating a plurality of locations in the PDSCH respectively corresponding to a plurality of UEs; and the location of the first channel allocated to the UE may be determined, from among the plurality of locations, based on A mod B, where A is a numerical identifier of the UE and B is a total number of the plurality of UEs.

The transmitting the paging message may include generating the paging message including a parameter indicating a cause of the paging message to be a small data transmission.

According to aspects of one or more example embodiments, a non-transitory computer-readable recording medium has recorded thereon instructions executable by at least one processor for performing the above method.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a paging procedure in the related art;

FIG. 2 illustrates a Radio Resource Control (RRC) Release message definition in the related art;

FIG. 3 illustrates a paging message definition in the related art;

FIG. 4 illustrates a flowchart of a method for performing an enhanced paging procedure by a user equipment (UE), in accordance with one or more embodiments;

FIG. 5 illustrates an example RRC Release message definition in accordance with one or more embodiments;

FIG. 6 illustrates an example paging message definition in accordance with one or more embodiments;

FIG. 7 illustrates an example of a physical downlink shared channel (PDSCH) location configuration in the time and frequency domains for small data transmission in an enhanced paging procedure, in accordance with one or more embodiments;

FIG. 8 illustrates an example of a plurality of PDSCH Occasions in the time and frequency domains following a paging message, in accordance with one or more embodiments;

FIGS. 9A and 9B illustrate small data transmission enhanced paging procedures in accordance with one or more example embodiments;

FIG. 10 illustrates a flowchart of a method for performing an enhanced paging procedure by a Radio Access Network (RAN) node, in accordance with one or more embodiments; and

FIG. 11 is a diagram of components of one or more devices, in accordance with one or more embodiments.

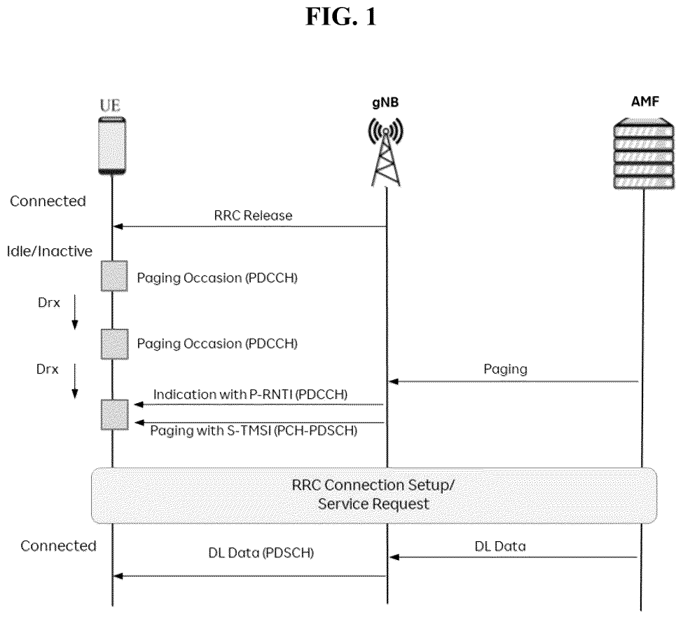

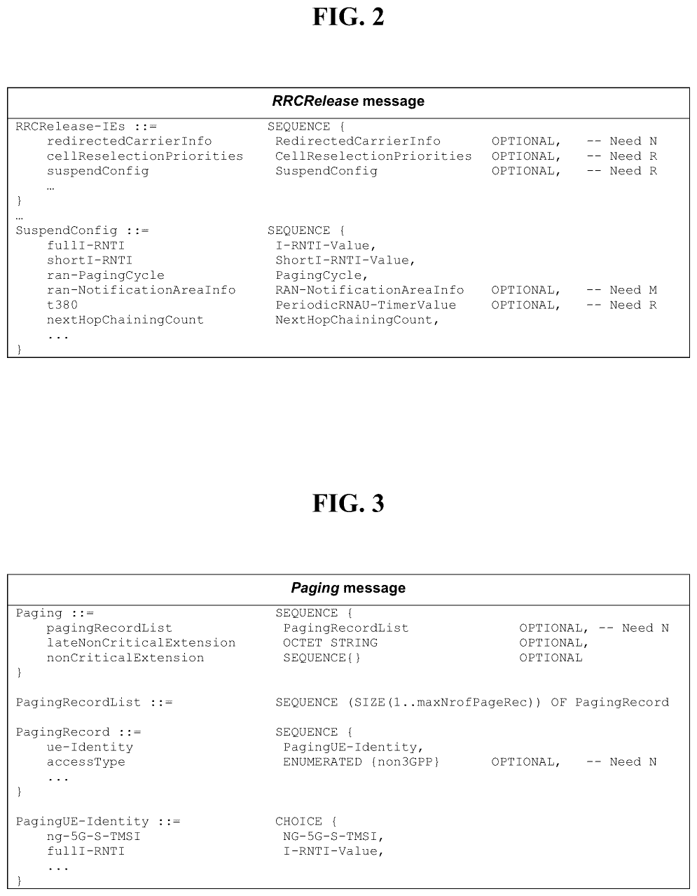

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

As set forth above, the related art paging procedure requires a user equipment (UE) to establish an RRC connection in order to receive data from the network. This state transition and attendant signaling required therefor results in a latency, radio resource utilization, and the high power consumption of the Radio Resource Control (RRC) Connected state in order to receive even just a small amount of downlink data.

Example embodiments provide a system and method that preconfigures a location in the physical downlink shared channel (PDSCH) in which data can be sent to a UE in an RRC Inactivate state. As a result, the UE can receive and read a small data transmission after decoding a paging message without performing the RRC setup procedure, thereby reducing latency, signaling overhead, radio resource utilization, and UE power consumption.

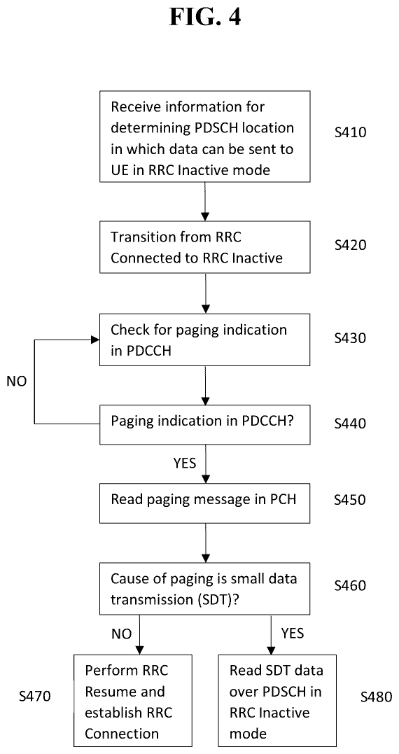

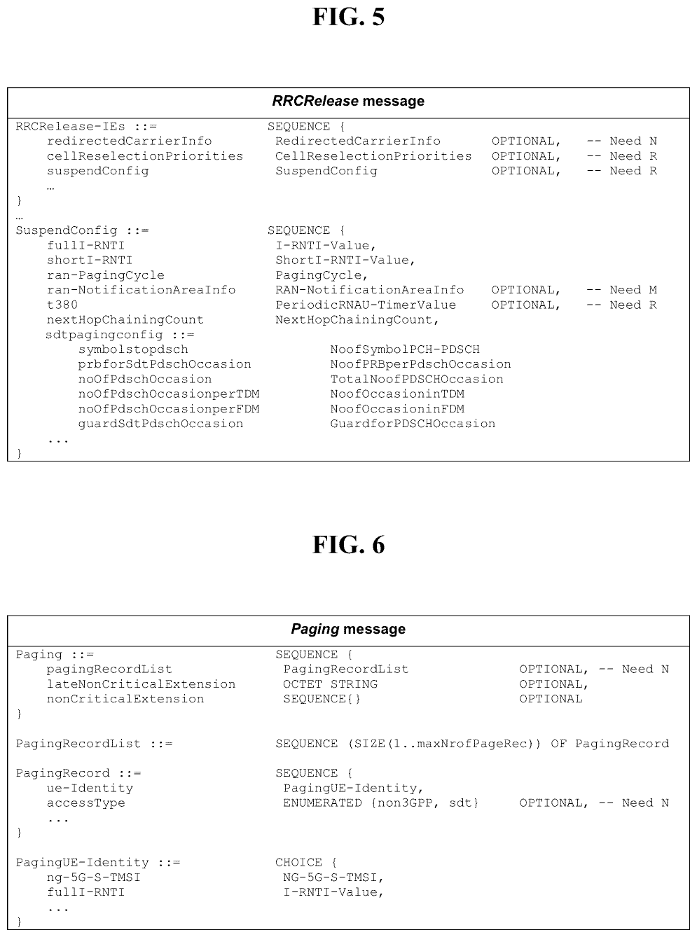

FIG. 4 illustrates a flowchart of a method for performing an enhanced paging procedure by a UE, in accordance with one or more embodiments. Referring to FIG. 4, at operation S410, the UE receives, from the network (e.g., base station or gNB), information indicating a PDSCH location in which data can be sent to the UE in an RRC Inactive mode. In an embodiment, the information may be included in an RRC Release message as one or more new fields or parameters, as illustrated by way of example in, and described below with reference to, FIG. 5. The UE and the network may communicate over a telecommunications network (e.g., Radio Access Network in accordance with a 3GPP standard or any other telecommunications network).

At operation S420, the UE transitions from an RRC Connected mode to the RRC Inactive mode.

At operation S430, the UE checks for a paging indication in the physical downlink control channel (PDCCH). For example, the UE in the RRC Inactive mode may periodically monitor a Paging Occasion in the PDCCH for a paging indication. The UE may perform this monitoring pursuant to a predetermined DRX cycle (e.g., as set or indicated in PDCCH-ConfigCommon).

If the UE does not identify a paging indication in the Paging Occasion (No at Operation S440), the UE performs operation S430 again.

If, however, the UE identifies a paging indication in the Paging Occasion (Yes at Operation S440), the UE reads a paging message in the paging channel (PCH) over the PDSCH at operation S450. For example, the UE may decode resource allocation information for the paging message from the PDCCH and identify the location (PDSCH resource block) in which the indicated paging message is sent.

FIG. 6 is an example paging message definition in accordance with an example embodiment. Referring to FIG. 6, the paging message according to an embodiment further identifies whether the cause of the paging is a data transmission (e.g., small data transmission (SDT)). To this end, the paging message according to an embodiment further enumerates “sdt” as a possible value for the access Type parameter. It is understood that this is merely an example, and one or more other embodiments are not limited thereto. That is, in one or more other embodiments, a different value or identifier than “sdt,” a different parameter than accessType, and a different filed than PagingRecord may be used to signal or indicate the cause of the paging as a small data transmission.

The UE decodes the paging message at operation S450 and may check whether its Serving Temporary Mobile Subscriber Identity (S-TMSI) is included in the paging record (PagingRecord). If its S-TMSI is not included in the paging record, then the UE may determine that the paging is not directed to it, and the process may return to operation S430.

Further, at operation S450, the UE may determine whether the cause of the paging is a data transmission (e.g., SDT). For example, referring to FIG. 6, the UE may check the paging record (PagingRecord) to see if the SDT cause is identified in the accessType parameter.

If the decoded cause in the paging message is not SDT (No at operation S460), the UE may perform the RRC resume procedure and reestablish the RRC connection at operation S470.

If, however, the decoded cause in the paging message is SDT (Yes at operation S460), the UE may read the SDT data over the PDSCH at operation S480 without performing the RRC resume procedure. That is, the UE reads the SDT data from the PDSCH while remaining in the RRC Inactive state. Here, the UE determines the location of the SDT data in the PDSCH using the information received in operation S410. For example, the information may be read from a field of the RRC Release message and used to determine the SDT location allocated to the UE in the PDSCH, as will be described in further detail below with reference to FIGS. 5, 7 and 8.

It is understood that, in various embodiments, one or more of the operations in FIG. 4 may be omitted, and/or one or more additional or different operations may be added.

FIG. 5 is an example RRC Release message definition including a small data transfer paging configuration field (stdpagingconfig) in accordance with an example embodiment. Referring to FIG. 5, sdtpagingconfig includes parameters for determining a PSDSCH location for SDT data allocated to a UE. These parameters may be the information received in operation S410 of FIG. 4, and are listed and described in Table 1 below:

TABLE 1

| Name of Parameter | Description |
|---|---|
| symbolstopdsch | Number of Symbols from PCH to PDSCH Occasion |
| prbforSdtPdschOccasion | Number of physical resource blocks (PRBs) per PDSCH Occasion |
| noOfPdschOccasion | Total number of PSDCH Occasions |
| noOfPdschOccasionperTDM | Number of PDSCH Occasions in Time domain |
| noOfPdschOccasionperFDM | Number of PDSCH Occasions in Frequency domain |
| guardSdtPdschOccasionTDM | Guard (TDM symbols) between 2 PDSCH Occasions in Time |
| | Domain |
| guardSdtPdschOccasionFDM | Guard (PRBs) between 2 PDSCH Occasions in Frequency Domain |

It is understood that the message definition of FIG. 5 and the parameters in Table 1 are merely an example, and one or more other embodiments are not limited thereto. For example, in various other embodiments, one or more of the above parameters (and the field name) may vary, one or more of the above parameters may be omitted, and one or more additional or other parameters may be included. Further, one or more of the above parameters may be Optional, e.g., may be omitted and/or understood as a default value (e.g., defined in a standard) or by a predetermined method (e.g., using one or more previously determined and/or standard-defined values).

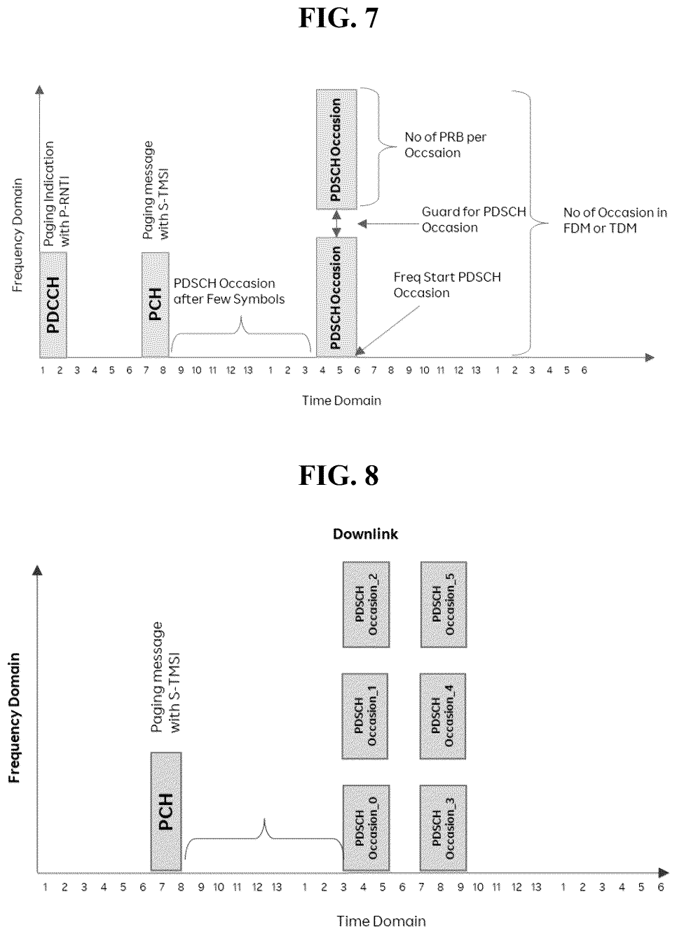

FIG. 7 illustrates an example of a PDSCH location configuration in the time and frequency domains for small data transmission in an enhanced paging procedure, in accordance with one or more embodiments. In particular, FIG. 7 illustrates the location configuration based on the parameters defined in the example RRC Release message of FIG. 5.

Referring to FIGS. 5 and 7, the PDSCH Occasion is a location of the PDSCH in which small data may be transmitted to a UE in RRC Inactive mode. The location of the PDSCH Occasion in the time domain (e.g., a first PDSCH Occasion in a sequence (or cycle) of PDSCH Occasions following a paging message in the PCH that indicates a small data transmission) may be defined relative to the PCH, as a number of symbols (or frames or sub-frames in other embodiments) from the PCH to the PDSCH Occasion. In an embodiment, the symbolstopdsch parameter may define a number of symbols from the end of a paging message to a start of the PDSCH Occasion, though it is understood that one or more other embodiments are not limited thereto. For example, according to another embodiment, the location of the PDSCH Occasion may be defined as a number of symbols from a start of the paging message to the start of the PDSCH Occasion.

The total number of PDSCH Occasions may define the number of different locations in one sequence (or cycle), following a paging message, in which small data may be transmitted respectively to different UEs. In this regard, each PDSCH Occasion may correspond to a different UE from among a predetermined set of UEs. The network (e.g., gNB or radio access network (RAN) element) and a particular UE may determine which PDSCH Occasion corresponds to that particular UE in a predefined manner. For example, according to an embodiment, the PDSCH Occasion corresponding to the UE may be determined using a unique identifier (e.g., S-TMSI) of the UE. In this case, and by way of example, the PDSCH Occasion corresponding to a UE (sequence number) may be determined by the UE and the network as S-TMSI mod n, where n is the number of PDSCH Occasions in one sequence (i.e., noOfPdschOccasion or noOfPdschOccasionperTDM×noOfPdschOccasionperFDM).

Further, the number of PDSCH Occasions in the time domain (noOfPdschOccasionperTDM) and the number of PDSCH Occasions in the frequency domain (noOfPdschOccasionperFDM) define the relative arrangement of the total number of PDSCH Occassions per sequence in the time and frequency domains. The guard between two PDSCH Occasions in the time domain (guardSdtPdschOccasionTDM) defines the offset or space in the time domain (e.g., a number of symbols) between sets of PDSCH Occasions (as shown in FIG. 7). Similarly, the guard between two PDSCH Occasions in the frequency domain (guardSdtPdschOccasionFDM) defines the offset or space in the frequency domain (e.g., a number of PRBs) between PDSCH Occasions.

Table 2 below provides an example of values set for parameters defined in the RRC Release message of FIG. 5:

TABLE 2

| Parameter | Value |
|---|---|
| symbolstopdsch | 8 Symbols |
| prbforSdtPdschOccasion | 4 PRBs |
| noOfPdschOccasion | 6 |
| noOfPdschOccasionperTDM | 2 |
| noOfPdschOccasionperFDM | 3 |

In the example of Table 2, the UE is divided into a group of six, which corresponds to the total number of PDSCH Occasions in one sequence (noOfPdschOccasion). The six PDSCH Occasions are divided into two sets in the time domain (noOfPdschOccasionperTDM=2). FIG. 8 illustrates arrangement of PDSCH Occasions per the example of Table 2, in the time and frequency domains.

Table 3 below illustrates a mapping between S-TMSI values for the six UEs and a corresponding PDSCH location (PDSCH Occasion sequence number) among the total number of PDSCH Occasions allocated to the set of UEs per the example of Table 2. In the present example, the mapping is determined by S-TMSI mod 6 (as noOfPdschOccasion=6). It is understood, however, that one or more other embodiments are not limited thereto, and other methods for mapping or allocating a UE to a PDSCH location for small data transmission may be performed.

TABLE 3

| | Sequence No. |
|---|---|
| S-TMSI | [(S-TMSI) mod 6] |
| 2401283158 | 4 |
| 2401283159 | 5 |
| 2401283160 | 0 |
| 2401283161 | 1 |
| 2401283162 | 2 |
| 2401283163 | 3 |

Based on the PDSCH location information for data transmissions defined in the RRL Release message according to an embodiment, and the method for mapping PDSCH locations (Occasions) to UEs as described above, the network (e.g., NG-RAN node or gNB) may schedule data transmissions (e.g., small data transmissions) on the PDSCH in sequence from a first symbol and first frequency occurrence to a last symbol and last frequency occurrence. Similarly, the UE can identify its PDSCH location for data transmissions in the same manner. Accordingly, data transmissions to the UE can occur while the UE remains in the RRC Inactive state, thereby reducing latency and signaling overheard involved in transitioning RRC states and conserving radio resources and power consumed by the RRC Connected state.

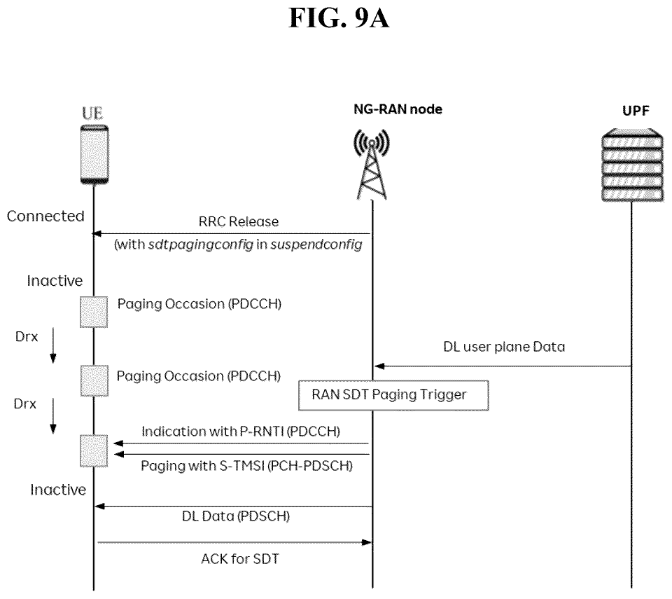

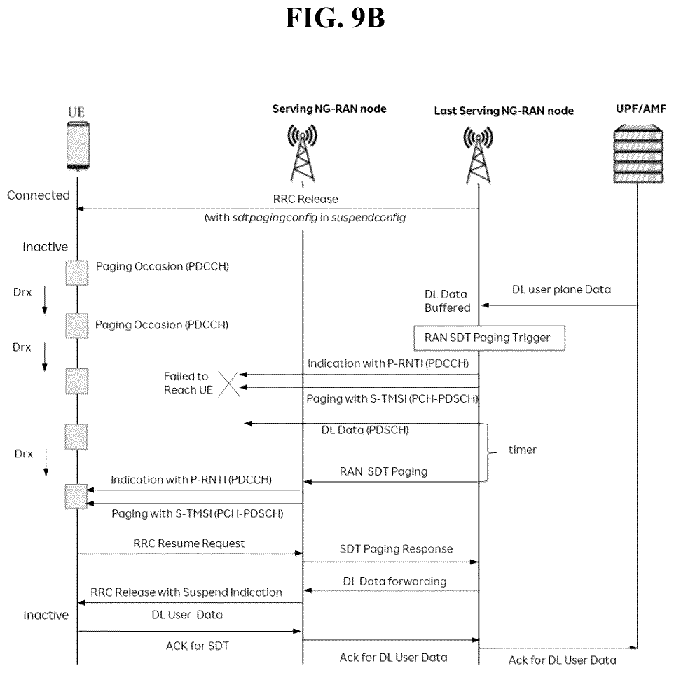

FIG. 9A illustrates a small data transmission enhanced paging procedure in accordance with an example embodiment. Referring to FIG. 9A, the UE transitions from the RRC Connected state to Inactive using the RRC Release procedure. To this end, an RRC Release message according to an embodiment is transmitted from the RAN node (e.g., gNB) to the UE, and includes information indicative of (or that can be used to determine) a location of the PDSCH allocated for small data transmissions to the UE in the RRC Inactive mode. For example, the RRC Release message may be defined as shown in FIG. 5, including PDSCH Occasion for SDT parameters in the SuspendConfig field.

Referring still to FIG. 9A, while in the inactive state, the UE periodically wakes up and monitors the PDCCH for a paging indication in one Paging Occasion per DRX cycle. For example, the Paging Occasion may be monitored based on a defined search space for paging (pagingSearchSpace) included in the PDCCH's cell specific configuration parameters (PDCCH-ConfigCommon).

When there is some downlink (DL) data to be transmitted to the UE in the RRC Inactive mode, the User Plane Function (UPF) of the core network may transmit DL user plane data to the RAN node (e.g., gNB). It is understood that in other embodiments or instances, a different function of the core network (e.g., the Access and Mobility Function (AMF)) may transmit or route the DL data to the RAN or the node serving the destination UE. The UPF or core network function may be unaware of the RRC mode that the UE is in.

Upon receiving the DL data, the RAN node may determine that the DL user plane data is a small data transmission (SDT) and may trigger or initiate an enhanced paging procedure (or SDT paging procedure) in accordance with one or more embodiments. To this end, the RAN node may transmit a paging indication on a Paging Occasion in the PDCCH. The RAN node may encrypt the paging indication using a paging radio network temporary identifier (P-RNTI), sent by the babse station in SIB. The RAN node may also transmit a paging message on the paging channel (PCH) of the PDSCH, the paging message configured by the RAN node to indicate the cause of the paging as a SDT. For example, the paging message according to an embodiment may be as defined in FIG. 6.

The UE may, in turn, use the P-RNTI to scramble or decrypt the paging indication in the PDCCH and then checks the paging message on the paging channel (PCH) of the physical downlink shared channel (PDSCH). Specifically, the UE decodes the paging message and checks whether its S-TMSI is included in the paging record (PagingRecord). The UE also checks whether the paging message indicates that cause of the paging is a SDT. For example, the paging message may be as defined in FIG. 6, and the UE may check the access Type to see if the cause is “sdt.”

If the UE finds its identity (S-TMSI) in the paging record of the paging message and determines that the cause of the paging is a SDT, it will then read the downlink data from the PDSCH at a location determined from the parameters set forth in the RRC Release message. Based on successfully reading the downlink data from the PDSCH, the UE may transmit an acknowledgment (ACK) to the RAN node. The UE reads the downlink data and sends the acknowledgement while staying in the RRC Inactive mode. As a result, the UE can receiving a SDT without performing an RRC setup procedure, thereby reducing latency and signaling and radio resource overhead.

FIG. 9A illustrates an example flow of the enhanced paging procedure in accordance with an embodiment, where the serving RAN node that performs the paging is the same as the last serving RAN node when the RRC Release procedure was performed. However, in one or more embodiments, if the serving RAN node that performs the paging is different from the serving RAN node that transmits the RRC Release message, then there will be a RAN paging failure, as shown in FIG. 9B.

FIG. 9B illustrates a small data transmission enhanced paging procedure in accordance with an example embodiment, where the serving RAN node and the last serving RAN node differ. Referring to FIG. 9B, the last serving RAN node transmits an RRC Release message according to an embodiment, which includes information indicative of (or that can be used to determine) a location of the PDSCH allocated for small data transmissions to the UE in the RRC Inactive mode. For example, the RRC Release message may be defined as shown in FIG. 5, including PDSCH Occasion for SDT parameters in the SuspendConfig field.

While in the RRC Inactive mode, however, the serving node changes, e.g., due to a handover procedure. As a result, a paging indication, a paging message, and a small data transmission (SDT) initiated by the last serving RAN node will fail to reach the UE. Upon determining the RAN paging failure (e.g., after a predetermined time period or a predetermined timer elapses after transmission of the DL data without receipt of an acknowledgement from the UE, the last serving RAN node may transmit a message to the UE's current serving RAN node to perform the SDT paging procedure. In this case, the serving RAN node may page over the RAN Notification Area (RNA) as a regular procedure, but without pushing the SDT data along with the paging message. As shown in FIG. 9B, the UE responds to the paging with a RRC resume procedure, and the serving node routes this paging response to the last serving node over the Xn interface. The last serving node then triggers DL data forwarding to the serving node using either an anchor relocation process or an anchor non-relocation process in accordance with example embodiments.

In the anchor relocation process, the serving RAN nodes retrieves the UE context from the last serving RAN node along with the SDT data. In the anchor non-relocation process, the serving RAN node tunnels the SDT data from the last serving RAN node without releasing UE context. In this case, ciphering, security, and response to the core network (e.g., 5GC) is ensured by the last serving RAN node.

Referring still to FIG. 9B, upon receiving the DL data forwarding from the last serving node, the serving node responds to the UE with an RRC Release with Suspend indication in order to keep the UE in the RRC Inactive mode. The serving RAN node piggybacks the SDT data with this indication.

In response, the UE reads the DL data and transmits an acknowledgment to the serving RAN node. The acknowledgement will be tunneled to the last serving RAN node and then the core network in the case of the anchor non-relocation, or will be sent directly to the core network in the case of the anchor relocation.

If the acknowledgement is received, the SDT paging procedure is completed. If no acknowledgement or a NACK is received, then the process is repeated by the RAN.

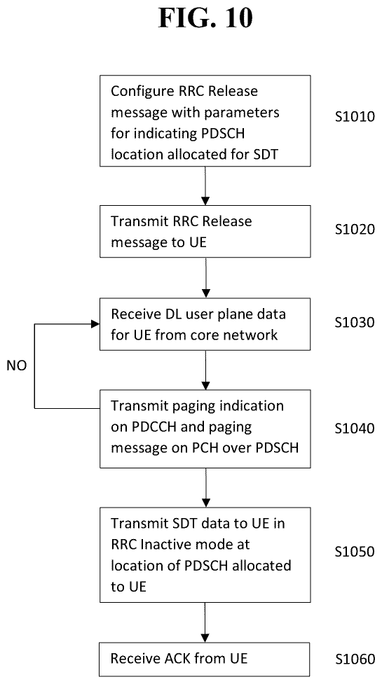

FIG. 10 illustrates a flowchart of a method for performing an enhanced paging procedure by a RAN node, in accordance with one or more embodiments. Referring to FIG. 10, the RAN node (e.g., gNB or base station of any type of RAN) configures an RRC Release message with parameters for indicating a location of the PDSCH allocated for small data transmissions to the UE in the RRC Inactive mode, in operation S1010. The RRC Release message according to an embodiment may be as defined in FIG. 5.

In operation S1020, the RAN node transmits the RRC Release message to the UE, in order to transition the UE from RRC Connected to RRC Inactive.

In operation S1030, the RAN node receives downlink (DL) user plane data for the UE from the core network. For example, the RAN node may receive SDT data from a core network function (e.g., UPF, AMF, etc.).

Based on receiving the DL data, the RAN node transmits a paging indication on a Paging Occasion in the PDCCH and a paging message on the PCH of the PDSCH, in operation S1040. Here, the RAN node may determine the DL data to be SDT data and, based on this determination, configure the paging message to indicate the cause of the paging as a SDT. For example, the paging message may be defined as in FIG. 6.

In operation S1050, the RAN node transmits the DL data (e.g., SDT data) to the UE in the location of the PDSCH allocated to the UE. For example, the RAN node may determine the location based on the parameters included in the RRC Release message and a unique identifier (e.g., S-TMSI) of the UE, as described above. When there is some downlink (DL) data to be transmitted to the UE in the RRC Inactive mode, the User Plane Function (UPF) of the core network may transmit DL user plane data to the RAN node (e.g., gNB). It is understood that in other embodiments or instances, a different function of the core network (e.g., the Access and Mobility Function (AMF)) may transmit or route the DL data to the RAN or the node serving the destination UE. The UPF or core network function may be unaware of the RRC mode that the UE is in.

In operation S1060, the RAN node receives an acknowledgement from the UE with respect to the transmitted SDT data. Operations 1040 through 1060 are performed while the UE remains in the RRC Inactive state.

If the RAN node does not receive the acknowledgement message within a predetermined period of time, it may then transmit a message to another RAN node to trigger the SDT paging process, as described above with reference to FIG. 9B.

It is understood that, in various embodiments, one or more of the operations in FIG. 10 may be omitted, and/or one or more additional or different operations may be added.

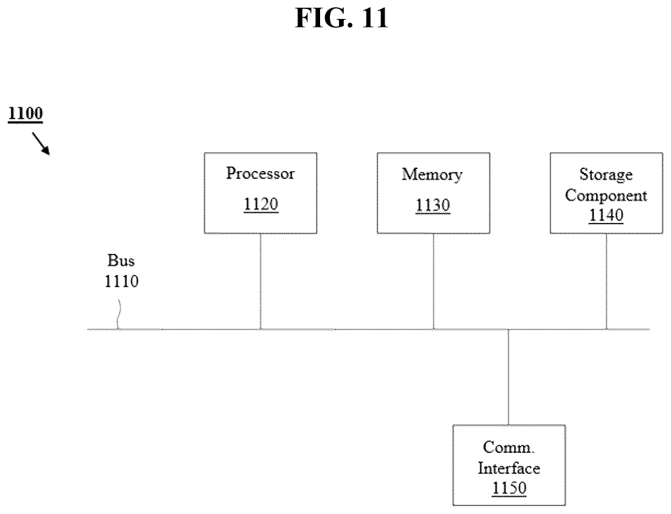

FIG. 11 is a diagram of components of one or more devices according to an example embodiment. Device 1100 may correspond to any of the devices described above (e.g., UE, base station, RAN node, core network device implementing core network function).

Referring to FIG. 11, the device 1100 may include a bus 1110, a processor 1120, a memory 1130, a storage component 1140, and a communication interface 1150. It is understood that one or more of the components may be omitted and/or one or more additional components may be included.

The bus 1110 includes a component that permits communication among the components of the device 1100. The processor 1120 is implemented in hardware, firmware, or a combination of hardware and software. The processor 1120 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 1120 includes one or more processors capable of being programmed to perform a function.

The memory 1130 includes a random access memory (RAM), a read only memory (ROM), and/or another type of dynamic or static storage device (e.g., a flash memory, a magnetic memory, and/or an optical memory) that stores information and/or instructions for use by the processor 1120.

The storage component 1140 stores information and/or software related to the operation and use of the device 1100. For example, the storage component 1140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The communication interface 1150 includes a transceiver-like component (e.g., a transceiver and/or a separate receiver and transmitter) that enables the device 900 to communicate with other devices, such as via a wired connection, a wireless connection, or a combination of wired and wireless connections. The communication interface 1150 may permit device 1100 to receive information from another device and/or provide information to another device. For example, the communication interface 1150 may include an Ethernet interface, an optical interface, a coaxial interface, an infrared interface, a radio frequency (RF) interface, a universal serial bus (USB) interface, a Wi-Fi interface, a cellular network interface, or the like.

The device 1100 may perform one or more processes or functions described herein. The device 1100 may perform operations based on the processor 1120 executing software instructions stored by a non-transitory computer-readable medium, such as the memory 1130 and/or the storage component 1140. A computer-readable medium is defined herein as a non-transitory memory device. A memory device includes memory space within a single physical storage device or memory space spread across multiple physical storage devices.

Software instructions may be read into the memory 1130 and/or the storage component 1140 from another computer-readable medium or from another device via the communication interface 1150. When executed, software instructions stored in the memory 1130 and/or storage component 1140 may cause the processor 1120 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for performing an enhanced paging procedure by a user equipment (UE), the method comprising:
receiving, from a radio access network (RAN) node, information for determining a location in a first channel allocated to the UE for downlink data transmissions while the UE is in a Radio Resource Control (RRC) Inactive mode;
transitioning from an RRC Connected mode to the RRC Inactive mode;
reading a paging message indicating the UE for paging; and
reading, while in the RRC Inactive mode, downlink data at the location in the first channel determined by the UE based on the received information.

2. The method according to claim 1, wherein the reading the downlink data comprises, based on determining that the paging message comprises information indicating a cause of the paging to be a small data transmission (SDT), reading the downlink data at the location in the first channel determined by the UE based on the received information.

3. The method according to claim 1, wherein the received information is received in an RRC Release message from the RAN node.

4. The method according to claim 1, wherein the first channel is a physical downlink shared channel (PDSCH).

5. The method according to claim 4, wherein the reading the paging message comprises:
identifying a paging indication in a Paging Occasion on a physical downlink control channel (PDCCH); and
based on identifying the paging indication, reading the paging message from a paging channel (PCH) on the PDSCH.

6. The method according to claim 4, wherein:
the received information comprises at least one parameter indicating a plurality of locations in the PDSCH respectively corresponding to a plurality of UEs; and
the UE determines the location allocated thereto, from among the plurality of locations, based on identification information of the UE.

7. The method according to claim 6, wherein:
the identification information of the UE is a numerical value; and
the UE determines the location allocated thereto, from among the plurality of locations, based on A mod B, where A is the identification information of the UE and B is a total number of the plurality of UEs.

8. The method according to claim 4, wherein:
the received information comprises:
a parameter indicating a distance, on a time domain, between the paging message on the PDSCH and a first location among a plurality of locations allocated for small data transmissions on the PDSCH, and
at least one parameter indicating the plurality of locations in the PDSCH respectively corresponding to a plurality of UEs; and
wherein the at least one parameter indicating the plurality of locations comprises at least one of a total number of the plurality of locations, a number of locations per a unit of the time domain, and a number of locations per a unit of a frequency domain.

9. A non-transitory computer-readable recording medium having recorded thereon instructions executable by at least one processor for performing the method of claim 1.

10. An apparatus for performing an enhanced paging procedure over a telecommunications network, the apparatus comprising:
a memory storing instructions; and
at least one processor configured to execute the instructions to:
receive, from a radio access network (RAN) node, information for determining a location in a first channel allocated to the apparatus for downlink data transmissions while the apparatus is in a Radio Resource Control (RRC) Inactive mode;
transition from an RRC Connected mode to the RRC Inactive mode;
read a paging message indicating the apparatus for paging; and
read, while in the RRC Inactive mode, downlink data at the location in the first channel determined based on the received information.

11. The apparatus according to claim 10, wherein the at least one processor is configured to execute the instructions to read the downlink data based on determining that the paging message comprises information indicating a cause of the paging to be a small data transmission (SDT).

12. The apparatus according to claim 10, wherein the received information is received in an RRC Release message from the RAN node.

13. The apparatus according to claim 10, wherein the first channel is a physical downlink shared channel (PDSCH).

14. The apparatus according to claim 13, wherein:
the received information comprises at least one parameter indicating a plurality of locations in the PDSCH respectively corresponding to a plurality of UEs; and
the at least one processor is configured to execute the instructions to determine the location allocated thereto, from among the plurality of locations, based on identification information of the apparatus.

15. The apparatus according to claim 14, wherein:
the identification information is a numerical value; and
the at least one processor is configured to execute the instructions to determine the located allocated thereto, from among the plurality of locations, based on A mod B, where A is the identification information of the apparatus and B is a total number of the plurality of UEs.

16. The apparatus according to claim 13, wherein:
the received information comprises:
a parameter indicating a distance, on a time domain, between the paging message on the PDSCH and a first location among a plurality of locations allocated for small data transmissions on the PDSCH, and
at least one parameter indicating the plurality of locations in the PDSCH respectively corresponding to a plurality of UEs; and
wherein the at least one parameter indicating the plurality of locations comprises at least one of a total number of the plurality of locations, a number of locations per a unit of the time domain, and a number of locations per a unit of a frequency domain.

17. A method for performing an enhanced paging procedure by a RAN node, the method comprising:
generating an RRC Release message comprising parameters for determining a location of a first channel allocated for small data transmissions to a UE in an RRC Inactive mode;
transmitting, to the UE, an RRC Release message to transition the UE from an RRC Connected mode to the RRC Inactive mode;
receiving downlink (DL) data for the UE from a core network;
based on receiving the DL data, transmitting a paging message to the UE; and
based on receiving the DL data, transmitting the DL data to the UE in the RRC Inactive mode at the location of the first channel determined by the RAN node based on at least the parameters comprised in the RRC Release message.

18. The method according to claim 17, wherein:
the first channel is a physical downlink shared channel (PDSCH);
the parameters in the RRC Release message comprise at least one parameter indicating a plurality of locations in the PDSCH respectively corresponding to a plurality of UEs; and
the location of the first channel allocated to the UE is determined, from among the plurality of locations, based on A mod B, where A is a numerical identifier of the UE and B is a total number of the plurality of UEs.

19. The method according to claim 17, wherein the transmitting the paging message comprises generating the paging message comprising a parameter indicating a cause of the paging message to be a small data transmission.

20. A non-transitory computer-readable recording medium having recorded thereon instructions executable by at least one processor for performing the method of claim 17.
